(19) United States
(12) Patent Application Publication
(10) Pub. No.: US 2009/0256346 A1
(43) Pub. Date: Oct. 15, 2009

(54) Personalized presentation folder and method of making same

(76) Inventor: Spencer Brody, Whitehouse Station, NJ (US)

Correspondence Address: HENRY I SCHANZER, 29 BROOKFALL RD, EDISON, NJ, 08817, US

(21) Appl. No.: 12/082,108

(22) Filed: Apr. 9, 2008

(51) Int. Cl. B42D 15/00; B31B 1/26; B31B 41/00; B31B 49/00

(52) U.S. Cl. 281/29; 493/243; 493/210; 493/267

(57) ABSTRACT

A presentation folder includes a generally rectangular folder sheet of width W and length L with a fold line extending along the length L to divide the folder sheet into a front section and a back section attached at the fold line. The front section includes structure for holding a customizable cover sheet which in combination with the front section functions as the front cover of a personalized presentation folder. The back section then functions as the back cover of the folder. In one embodiment the cover sheet is of a size and shape to be compatible with standard computer/printer equipment and the structure for holding includes an alignment and stop structure for ensuring the correct positioning of the cover sheet within the front section and attachment means for securing the cover sheet to the front section. A pocket flap may be used to form a pocket on the inner surface of the back section. The folder sheet with the alignment and stop structure and the pocket flap may be patterned from the same sheet of material at the same time.

### BACKGROUND OF THE INVENTION

The present invention relates generally to folders and in particular to a personalized or customizable presentation folder.

Different types of file folders are known for use in a very wide range of applications. For example, file folders may be used to hold papers, documents, reports and any suitable object. The different file folders also find use in an untold number of different environments such as school, home, offices and business. It is known to provide preformed or custom folders with or without pockets, and several methods have been described in the prior art for making pocket folders.

However, a need exists for making a presentation folder whose cover (e.g., front sheet) can be customized or personalized by a user. There is a further need to provide a cover or cover sheet which can be personalized manually or by a standard computer/printer to form a presentation folder. There is a further need to form such a presentation folder easily and cheaply.

It is therefore an object of the present invention to provide a presentation folder whose cover (e.g., front sheet) can be customized or personalized by a user using a standard printer.

It is another object of the present invention to provide a simple and inexpensive method of making personalized presentation folders, which are simple to make and to assemble by a consumer.

It is an additional object of this invention to provide a kit comprising the different components used to make a customizable presentation folder.

The foregoing and other objects and features of the present invention will now be described in the ensuing detailed description of the invention taken in conjunction with the accompanying drawings which form part of this application.

### SUMMARY OF THE INVENTION

The present invention provides a simple and inexpensive method of making personalized presentation folders. A personalized folder embodying the invention includes a folder sheet of width W and length L with a fold line extending along the length L to divide the folder sheet into a front section and a back section, attached at the fold line. The back section (or panel) may be of width (W-D) and length L and the front section may be of width D, where D is less than (W-D). The front section includes attachment and alignment means for enabling a user to align and attach a cover sheet to the front section to form the front cover of the folder. The back section [panel] functions as the back cover of the folder and may include a pocket for holding any suitable object. Typically, the attachment and alignment means and the pocket are formed and mounted on the inner surface of the front and back sections.

A personalized presentation folder embodying the invention may be formed of a single patterned folder sheet to which may be appended the structure for forming an alignment and end stop and a flap for forming a pocket and tabs for reinforcing selected edges.

A method for forming a presentation folder embodying the invention includes forming a fold-line in a patterned generally rectangular folder sheet configured to also include an alignment and stop structure and a pocket flap. The fold line is used to divide the folder sheet into a front section and a back section attached at the fold line. The alignment and stop structure is preferably attached to the inner surface of the front section to control the passage of the cover sheet and to stop the travel of the cover sheet along a predetermined line. An attachment means is also preferably attached to the inner surface of the front section for enabling a cover sheet, which can be independently personalized, to be securely mated with the front section to form the front cover of the personalized folder. The back section may include a pocket-forming structure attached to the inner surface of the back section.

The front and back sections of the presentation folder may be formed from a single preformed patterned (cut) folder sheet which can be folded to form the back section of the folder and the front section to which a personalized cover sheet can be secured to form a personalized presentation folder.

The present invention also provides a kit having one or more preformed pockets and sheet folders which can be used to form the presentation folder as hereinbefore described.

### BRIEF DESCRIPTION OF THE DRAWINGS

In the drawings, which are not all drawn to scale, like reference numerals denote like components; and

FIG. 1A is a plan “inside” view of a folder sheet used to form the back cover and a section of the front cover of a presentation folder embodying the invention;

FIG. 1B is a plan view of a cover sheet, which can be personalized, suitable for mating with the front cover section of FIG. 1A to form a presentation folder in accordance with the invention;

FIG. 1C is a plan view of the “inner” surfaces of a presentation folder embodying the invention illustrating the formation and location of alignment and stops and a pocket flap with a cover sheet ready to be attached to the cover sheet holding section;

FIG. 1D is an isometric diagram of the internal surfaces of the back cover and the front cover holding section in accordance with the invention;

FIG. 1E is an isometric diagram of a presentation folder embodying the invention; and

FIG. 1F is a plan view showing the alignment stop may be located at or near the fold line.

### DETAILED DESCRIPTION OF THE DRAWINGS

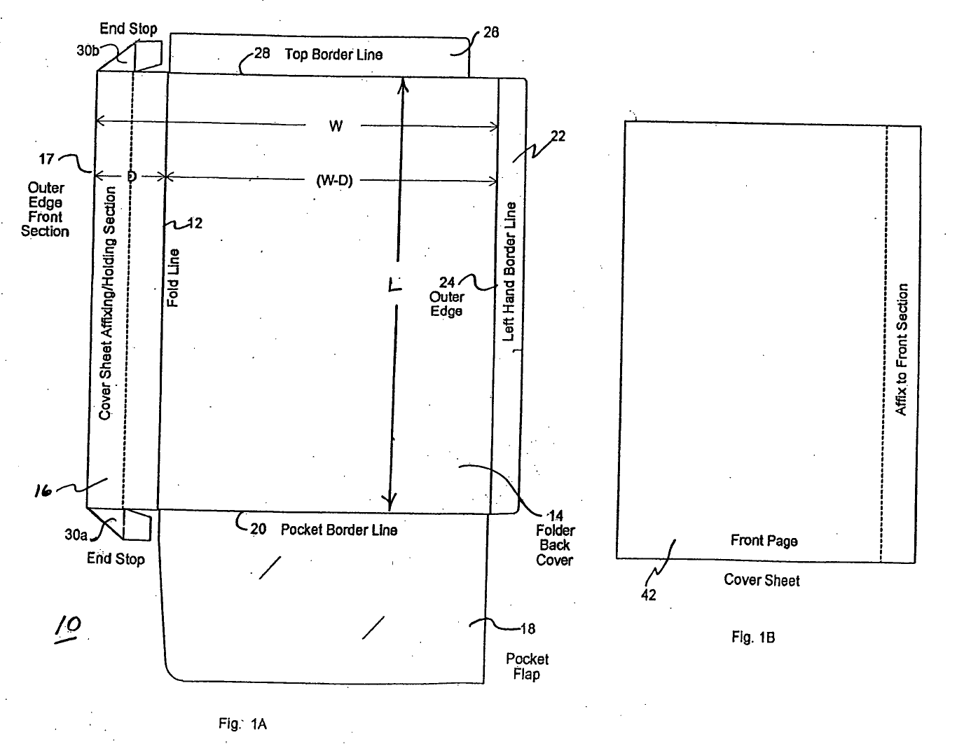

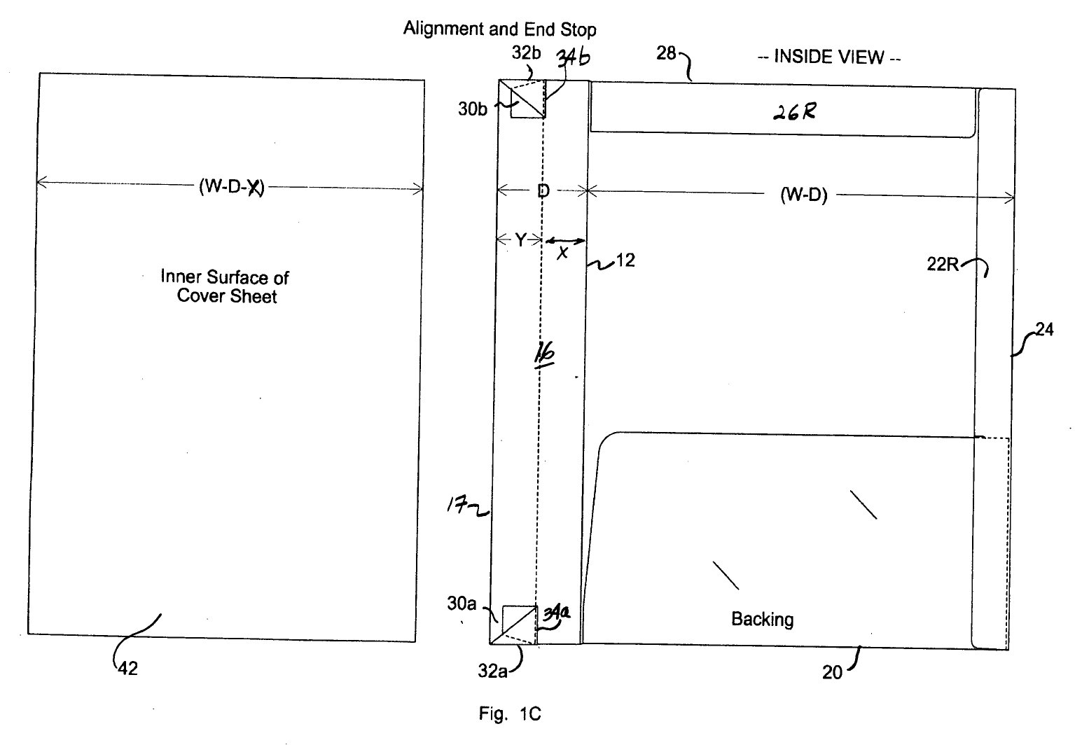

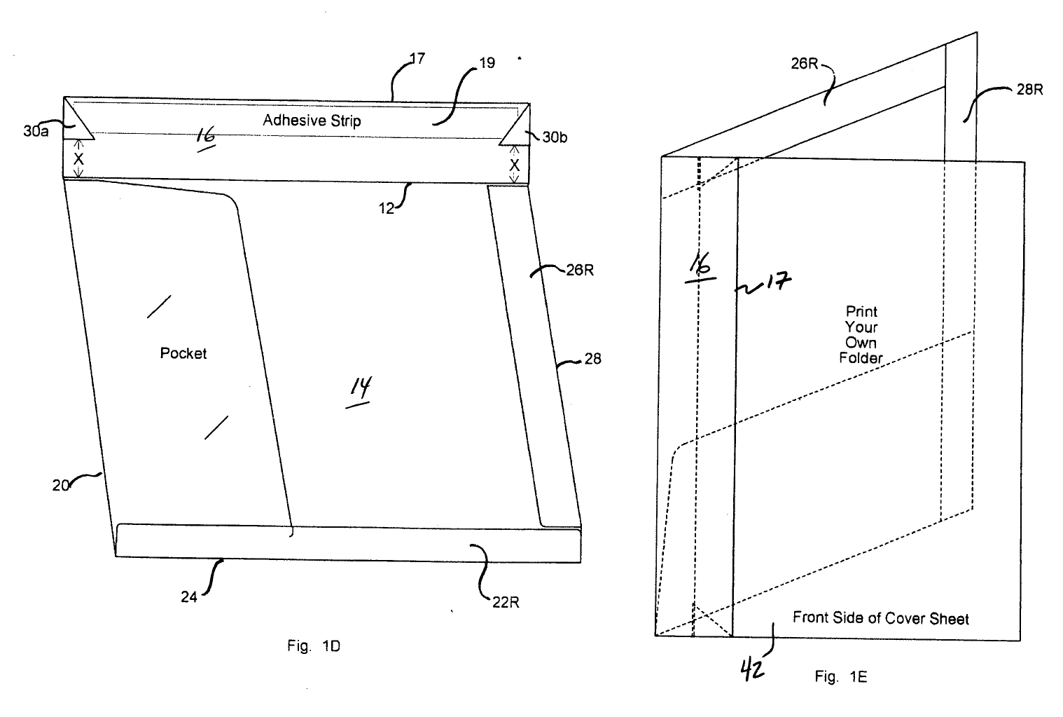

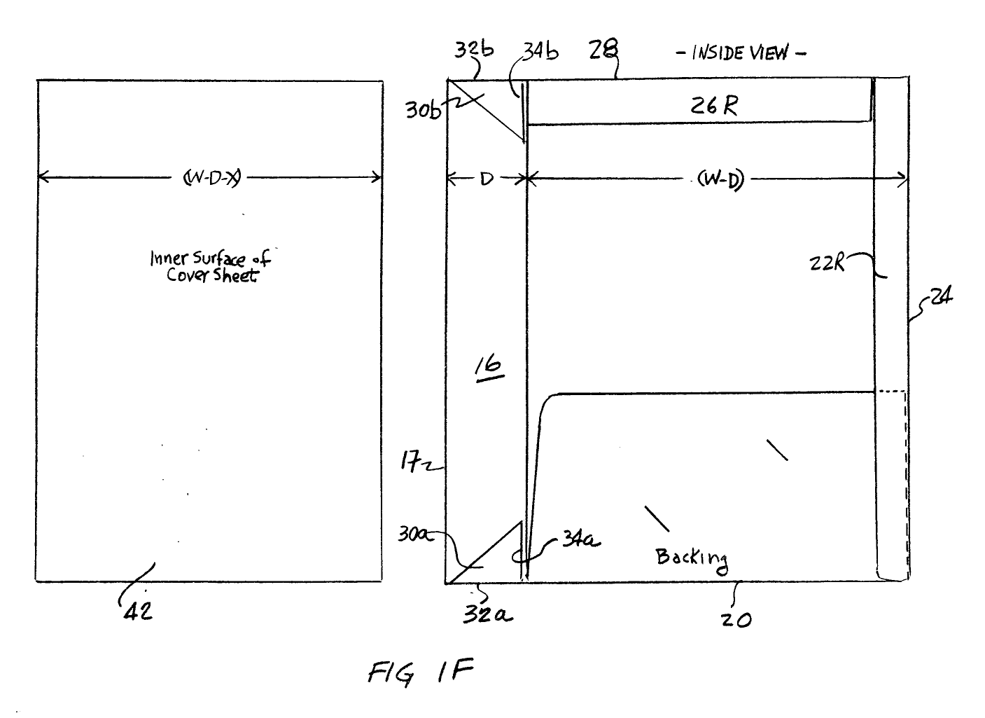

Referring first to FIG. 1A, there is shown a generally rectangular folder sheet 10 made of cardboard or multi-ply paper suitable for making a presentation folder in accordance with the invention. The folder sheet 10 has a scored fold line 12 along which the sheet 10 can be folded to form a back section 14 (arbitrarily shown on the right side of FIG. 1A) and a front section 16 (arbitrarily shown on the left side of FIG. 1A). Back section 14, which is intended to function as the back cover of a personalized folder, is shown to have a width of (W-D) and a length L. Front section 16 is shown to have a width D between fold line 12 and outer edge 17 and to also have a length L. By way of example, the dimension of (W-D) is in the range of 9 and ½ inches and D may be in the range of 2 inches, while L is approximately 12 inches. These dimensions are by way of example only; the actual sizes may be significantly different, being a function of the configuration desired by the manufacturer and/or the user. As already noted, it is intended to attach a cover sheet (e.g., 42 in FIG. 1B) to the front section to form the front cover of the personalized folder.

Appended to section 14 of sheet 10 is a panel, or flap, 18 which can be folded back, on the “inside” surface of section 14, along a pocket border line 20 to form a pocket (as shown in FIGS. 1C, 1D, 1E and 1F) to hold papers and/or any other suitable object, normally held by a folder pocket. A tab (border) region 22 shown extending to the right of section 14 in FIG. 1A may be retracted along a border line 24 (to the right in FIG. 1A) to form retracted region 22R so as to secure and hold down the pocket flap and to add rigidity and strength to the border region. Similarly, a tab (border) 26 shown extending above section 14 in FIG. 1A may be retracted down along a border line 28 to form retracted region 26R to add rigidity and strength to the top border region and back cover.

Appended to section 16 of section 10 is a structure (30a, 30b) for forming alignment and stops for a cover sheet 42 (see FIG. 1B) to be mated with section 16. The structure 30a, 30b (shown in FIG. 1A) includes tabs (extensions) which may be folded back to form alignment guides and stops for controlling the sliding of the cover sheet 42 along the inner surface of section 16 and ensuring that the cover sheet stops uniformly along a predetermined line at a given distance from fold line 12 (and edge 17). Thus, the alignment guides/stops 30a, 30b for receiving a cover sheet as shown in the figures function to guide the cover sheet 42 and control its slide along the inner surface of section 16. Thus, structures 30a, 30b serve multiple purposes. They function to guide the slide of a cover sheet 42, to help align sheet 42 so it ends up being uniformly straight parallel to the edges and fold line and as a well defined stop against which the cover sheet rests. Alignment guide/stop structures comparable to 30a, 30b could be formed independently of the base sheet 10. However, when formed as part of the initial formation of sheet 10 and sections 14 and 16, their accurate and precise placement is ensured. This eliminates possible misalignment of the cover sheet alignment guides and stops

As shown in FIG. 1B, the front page (cover sheet) of the personalized folder may be a sheet of regular or heavier gauge paper of generally standard size. In many cases the size of the cover sheet is dictated by the desire to be able to design and print the personalized cover sheet using a standard commercially available computer and printer. The constraint to be compatible with any standard printer is met with the presentation folders of the invention. Note that this is not a necessity; but, it makes it easier for a user to design (or have designed) a folder cover using a computer and to have the design printed on the cover. Typically, the design formed on the cover sheet will face the outside or external surface of the personalized folder. However, there is nothing to prevent a user from personalizing the “outside” and/or the “inside” surfaces of the cover sheet used to form the personalized folder.

FIG. 1C shows a top view of the inner surfaces of the back cover 14 and the front section 16 ready for assembly with cover sheet 42. In FIG. 1C the alignment and end stops 30a, 30b are shown to include an L shaped structure (32a, 34a and 32b, 34b). The horizontal portions of the L (32a, 32b) extend horizontally along the top most and bottom borders of section 16 to hold and/or properly center the cover sheet. The vertical portions of the L (34a, 34b) extending generally orthogonally to the top and bottom borders. These will function to limit or stop the travel of the cover sheet in the horizontal direction. The cover sheet will be secured by pushing the cover sheet along the back ends of the end stops and using an adhesive strip (shown in FIG. 1D) to firmly attach the cover sheet to section 16 to form the front cover of the presentation folder. FIG. 1D shows a two sided adhesive tape 19, having a protective layer, mounted on the inside surface of section 16. When a cover sheet 42 is mated with section 16, which is to function as the holder of the cover sheet, the protective layer of the adhesive strip is peeled away, allowing the cover sheet to bind with the adhesive strip and the inner surface of section 16. The cover sheet 42 may be sized and the guides 30a, 30b may be located to cause the cover sheet to be flexed away (convex-like) from the tape to ease the insertion and guidance of the cover sheet before attachment (adhesion).

FIG. 1D illustrates the appearance of the inner surfaces of sections 14 and 16 of sheet 10 when fully assembled and ready for being combined with a cover sheet. It should be appreciated that, in accordance with one aspect of the invention, the sheet 10 shown in FIG. 1A may be cut out and formed from a single unitary folder sheet and processed to provide the various structures described above and then assembled to have the form shown in FIG. 1D, with the adhesive strip 19 being subsequently added.

FIG. 1F illustrates that the alignment guide/stops may be positioned so the stop (34a, 34b) is at or near the fold line 12.

The presentation folder has been shown as a rectangular folder. However it should be understood that any other suitable configuration or dimensions of the folder may be used. For example, the folder may be square-shaped; or one section may be wider than the other. If it is intended to insert business cards or similar cards in the pocket, the pocket may be provided with one or more slits conveniently dimensioned for insertion of such cards.

The folder sheet with the alignment end structure and the pocket flap, as well as the tabs and borders may be patterned out of a single base sheet, and at the same time, by known die-cutting methods using conventional die-cutting equipment, and the patterned sheets are scored by conventional die-cutting methods.

In accordance with the present invention, consumers may be provided with a kit which contains, in non-assembled form, the components used for making the described presentation folders. It is thus contemplated that such a kit would comprise at least one, but preferably a plurality of components of the type shown in FIGS. 1D and 1E and cover sheets 42 which would be compatible dimensionally with the depth and length of section 16.

A process for forming a base folder as shown in FIG. 1A and for subsequently transforming the base folder of FIG. 1A to define the back (14) and front (16) sections, as shown in FIGS. 1C, 1D, 1E and/or 1F may include the followings manufacturing steps:

A) Loading—Paper is piled into the loading section of a die cutting press.
B) Cutting—The paper is cut into sheets which are fed into a flat platen which incorporates a steel rule die which incorporates a previously designed pattern. The steel rule die is pressed against another steel platen and in effect punches out the desired shape of the base folder shown in FIG. 1A.
C) Stripping—This section strips out internal scrap with pins.
D) Blanking—The folder is pushed through a female template and loaded onto pallet. This completes the die cutting process to produce a folder of the type shown in FIG. 1A.
E) Loading/form—the folders cut and stripped as shown in FIG. 1A are then brought to folding/gluing equipment. Folders cut and stripped as shown in FIG. 1A are loaded into bottom fed friction feeder and pulled into and via a series of rollers. The “stop tabs” are pulled up and glue is added to the end stop tabs and to the top (26) and side (22) reinforcement tabs which are readied to be folded back with an with an angled forming plow. Concurrently, the pocket flap 18 is also folded back.
F) Right angle and Final fold—a folder is then positioned for final folding step. Rollers force the folder body through another series of forming plows so that the reinforcement flap (22R) is folded over the formed pocket while on the opposite side front section 16 is also folded. The adhesive strip 19 may be applied before or after the final fold.
H) Squeeze Roll—Folder enters squeeze blanket so pressure is applied to keep glued areas closed for a period of time allowing them to cure. Folders of varying color (based on selected color of the paper used in step A, above) and of different size if so designed are ready for packaging with suitable cover sheets 42.

So formed, each folder has a back section 14 and front section 16, which is now rendered suitable for mating with a cover sheet 42. A user may personalize and customize the cover sheet to bear the user's design. The user e may then assemble a cover sheet with a corresponding folder (FIG. 1D, 1E or 1F) to complete a “Print Your Own) pocket folder.

It can be appreciated from the foregoing description and drawings that the present invention is not limited to the embodiment herein described and that different variations are possible. Such variations are nevertheless obvious and are suggested from the present description.

What is claimed is:

1. A presentation folder comprising:
a folder sheet having a portion of width W and selected length with a fold line extending along the selected length to divide the folder sheet into a front section and a back section attached to each other along the fold line; the back section being of width (W-D) and the front section being of width D, where D is less than (W-D);
the front section including means for enabling a user to align and attach a customizable cover sheet to the front section to form a personalized front cover for the folder; and
the back section intended to function as the back cover of the folder.

2. A presentation folder as claimed in claim 1 wherein the front and back sections have inner surfaces facing each other when the front and back sections are folded toward each other along the fold line; and wherein said means for enabling a user to align and attach a customizable cover sheet to the front section includes attachment means and alignment and stop means formed along the inner surface of the front section; and wherein said attachment means includes an adhesive strip for selectively attaching the front section to the cover sheet.

3. A presentation folder as claimed in claim 1 wherein said alignment and stop means formed along the inner surface of the front section define a structure to ensure that the vertical and horizontal edges of the cover sheet are in alignment with corresponding vertical and horizontal edges of the front section and that the cover sheet extends a predetermined distance along the front section.

4. A presentation folder as claimed in claim 2 wherein the front section has an upper edge, a lower edge and an outer edge a distance D from the fold line; and wherein said alignment means includes a pair of alignment and stop structures having an “L” shaped portion, where the horizontal part of the L shaped portion is disposed along opposite upper and lower edges of the front section for controlling the positioning of a cover sheet between the horizontal part of the L shaped portions and wherein the vertical part of the L shaped portion is disposed a predetermined distance from the outer edge of the front section for stopping the travel of the cover sheet at said predetermined distance from the outer edge of the front section.

5. A presentation folder as claimed in claim 2 wherein the folder sheet is formed to include structure for forming the alignment and stop means along the front section and a flap for forming a pocket along the back section.

6. A presentation folder as claimed in claim 5 wherein the alignment and stop means are formed by folding the corresponding structure and attaching the folded structure to the inner surface of the front section; and wherein said flap is folded to form a pocket for the folder along the inner surface of the back section.

7. A presentation folder as claimed in claim 1 wherein the cover sheet may be personalized by means of standard commercially available computer and printing equipment prior to attachment to said front section.

8. A presentation folder as claimed in claim 7 wherein said front section and said cover sheet define a personalized presentation folder.

9. A method for forming a presentation folder comprising the steps of:
forming a folder sheet having a generally rectangular portion of width W and length L with a fold-line to divide the rectangular portion into a front section and a back section which are attached to each other at the fold line; the front section extending a distance D from the fold line and the back section extending a distance (W-D) from the fold line; where (W-D) is greater than D;
forming said folder sheet with an alignment stop structure attached to the front section; and
shaping the alignment and stop structure for controlling the positioning of a cover sheet attachable to the front section for forming a front cover for the folder.

10. A method for forming a presentation folder as claimed in claim 9, wherein said folder sheet is also formed having a pocket flap and the method includes the step of folding the pocket flap along the inner surface of the back section.

11. A method as claimed in claim 9 comprising the step of positioning the alignment and stop structure along the inner surface of the front section to ensure that the vertical and horizontal edges of the cover sheet are in alignment with corresponding vertical and horizontal edges of the front section and that the cover sheet extends a predetermined distance along the front section going from its outer edge to the fold line.

12. A method as claimed in claim 9 wherein the folder is personalized by enabling a user to attach a cover sheet containing user information to the front section using the alignment stop structure extending along the front section of the folder.

13. A method as claimed in claim 9 wherein said folder sheet is formed from a single sheet which is scored and lined to permit the formation of the front and back sections and the alignment and end stops and a pocket.

14. A kit for making a personalized presentation folder including:
a generally rectangular folder sheet of width W and length L with a fold line extending along the length L to divide the folder sheet into a front section and a back section attached at the fold line; the front section includes structure for attaching a customizable cover sheet which in combination with the front section functions as the front cover of the personalized presentation folder; the back section then functions as the back cover of the folder; and
a cover sheet of a size and shape to be compatible with standard computer/printer equipment; and wherein the structure for attaching includes an alignment and stop structure for ensuring the correct positioning of the cover sheet with the front section and attachment means for securing the cover sheet to the front section and forming the font cover.

15. A kit as claimed in claim 14, wherein the back cover includes a pocket on the inner surface of the back section.

16. A kit as claimed in claim 14 wherein the folder sheet with the alignment and stop structure and the pocket are formed from the same sheet of material.
